(19) United States
(12) Patent Application Publication
(10) Pub. No.: US 2005/0205315 A1
(43) Pub. Date: Sep. 22, 2005

(54) Light armored vehicle

(76) Inventor: Joshua Gordon, Mitzpeh Yericho (IL)

Correspondence Address: Edwards & Angell, LLP, P.O. Box 55874, Boston, MA, 02205, US

(21) Appl. No.: 10/801,298

(22) Filed: Mar. 16, 2004

(51) Int. Cl. B60K 11/00

(52) U.S. Cl. 180/68.1

(57) ABSTRACT

A light armored vehicle for military use and, in particular, for rapid response applications, which is light-weight, reliable, fast, and highly maneuverable, which can negotiate many types of terrains and conditions, and which has an armored enclosure configured to provide a desired degree of protection to the occupants thereof without compromising the maneuverability of the vehicle.

### FIELD OF THE INVENTION

The present invention relates to armored vehicles, in general, and to light armored vehicles for military applications, in particular.

### BACKGROUND OF THE INVENTION

In many military applications, the speed and maneuverability of all terrain vehicles or off road vehicles, such as those known as “dune buggies,” are desirable. However, the open structure of these vehicles does not provide a user with any protection against even small arms fire, such as would be expected in a combat zone. U.S. Pat. No. 6,547,027 to Kalhok et al. and U.S. Pat. No. 6,626,260 to Gagnon et al., both included herein by reference, each describe an “All terrain vehicle” which is versatile, maneuverable, and fast, but in which the rider is totally exposed.

U.S. Pat. No. 5,251,713 to Enokimoto, included herein by reference, describes a “Four wheel vehicle” exemplary of off road vehicles known as ‘dune buggies’. The vehicle described therein includes a tubular frame enclosing the cockpit wherein the passengers sit, but is still open except for the frame.

U.S. Pat. No. 4,280,393 to Giraud, et al describes a “Light weight armored vehicle” for military applications which is based on a standard automobile which is armored. The vehicle described therein is different from prior armored vehicles in that it has a double armored enclosure: a thicker-walled, inner enclosure to protect the riders and a thinner-walled, outer enclosure to protect additional parts of the vehicle. Gagnon cites the advantage of not using one, thick-armored, outer enclosure as providing significant weight reduction. Gagnon further describes a tank employing the same double envelope to analogous advantage. In neither case, however, does Gagnon disclose or imply a vehicle with the speed, versatility, and maneuverability of an all terrain vehicle.

### SUMMARY OF THE INVENTION

The present invention seeks to provide a light armored vehicle for military use and, in particular, for rapid response applications, which is light-weight, reliable, fast, and highly maneuverable, which can negotiate many types of terrains and conditions, and which has an armored enclosure configured to provide a desired degree of protection to the occupants thereof without compromising the maneuverability of the vehicle.

There is thus provided, in accordance with a preferred embodiment of the invention, a light, armored, all terrain vehicle which includes:
a chassis with an armored envelope mounted thereon to protect preselected components and the occupants thereof, providing a predetermined degree of protection, preferably against a 7.62 mm armor-piercing round, thereto;
at least four wheels including two rear wheels;
an engine for producing driving energy;
a total drive train for transmitting driving energy which includes a transmission, a drive shaft, and a rear differential;
a rear drive for transmitting driving energy from the total drive train to the rear wheels;
a frame including at least one box channel providing structural stability and strength to the vehicle;
an air intake arrangement to provide air to the engine; and
a cooling arrangement for cooling the engine,
   wherein the total drive train, the rear drive, the at least one box channel, and the air intake arrangement are enclosed within the armored envelope.

Additionally in accordance with a preferred embodiment of the invention, the armored envelope includes perpendicular portions, parallel portions, and angled portions, with respect to the chassis. The perpendicular portions are fabricated of relatively thick armored plate, preferably of ballistic steel of a thickness of at least 10 mm; and the angled and parallel portions are fabricated of relatively thin armored plate, preferably of ballistic steel of a thickness in the range of 3 to 7 mm. Further, the angled portions are oriented at an angle in the range of 45° to 70° relative to the horizontal surface. In addition, the armored envelope includes doors, which have overlap portions at the seams between them and the armored envelope, providing protection from penetration of projectiles via the seams, and unopenable window portions, which preferably include gun ports at preselected locations, to provide visibility from within the armored envelope. In accordance with a further preferred embodiment of the invention, the armored envelope further includes an undercarriage fabricated of armor plate, thereby completing the enclosure provided by the armored envelope. Additionally, the armored envelope further includes a hatch located in an upper portion thereof.

In accordance with a preferred embodiment of the invention, the rear drive includes an independent rear wheel drive train for each of the rear wheels. Additionally, the wheels include tires fabricated to continue to function when deflated, preferably bead lock tires. The box channel further includes an air conduit for the air intake arrangement.

Further in accordance with a preferred embodiment of the invention, the cooling arrangement includes a radiator and at least one or two fans, with a predetermined spacing therebetween, preferably in the range of 3 to 4 inches, to allow sufficient air circulation through the radiator for effective functioning of the cooling arrangement.

The vehicle further includes, in accordance with an additional preferred embodiment of the invention, a climate control system configured to NBC standards and which preferably includes at least one blower for maintaining positive air pressure within the armored envelope and a filtered air inlet.

### BRIEF DESCRIPTION OF THE DRAWINGS

The present invention will be more fully understood and appreciated from the following detailed description, taken in conjunction with the drawings, in which:

FIG. 1 is a block diagram of a light armored vehicle, in accordance with a preferred embodiment of the present invention;

FIG. 2 is an exterior view of the light armored vehicle, depicted in FIG. 1, constructed and operative in accordance with a preferred embodiment of the present invention;

FIG. 3A is an enlarged view of the interior of a door of the light armored vehicle of FIG. 2;

FIG. 3B is a cross-sectional inset of the seam where the door meets the side of the light armored vehicle of FIG. 2;

FIG. 4 is a frontal view of the light armored vehicle of FIG. 2, with the hood opened;

FIG. 5 is an interior view of the light armored vehicle of FIG. 2;

FIG. 6 is a detailed view of the drive train and the final drive of the rear wheels of the light armored vehicle of FIG. 2; and

FIG. 7 is a block diagram of a light armored vehicle, in accordance with a further embodiment of the present invention.

### DETAILED DESCRIPTION OF THE INVENTION

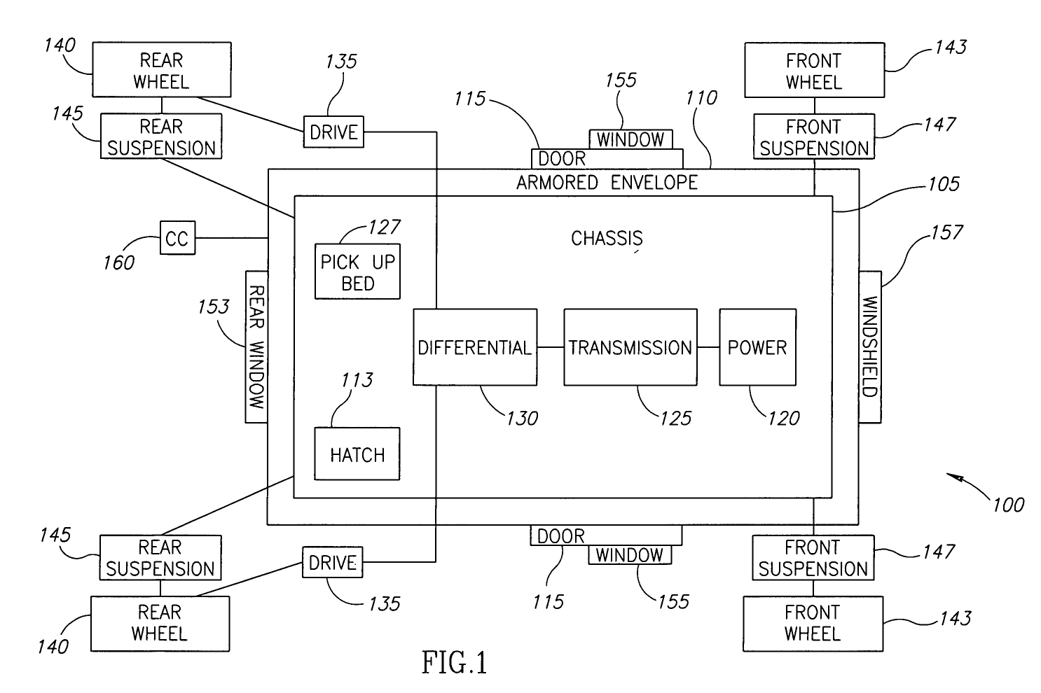

Referring now to FIG. 1, there is shown a block diagram of a light armored vehicle, referred to generally as 100, operative in accordance with a preferred embodiment of the present invention. The present invention is an all terrain or off road vehicle 100 suitable for rapid response applications in military situations. Additionally, it is light, fast, highly maneuverable, and configured to function in many types of terrains and conditions, while providing protection to the occupants therein. Protection is provided by armored envelope 110 mounted on vehicle chassis 105. The present preferred embodiment is based on an all terrain or off road vehicle known as a “dune buggy,” however it should be noted that the present invention includes a light armored vehicle which may alternatively be based on any other suitable type of all terrain vehicle.

In the present preferred embodiment, armored envelope 110 has doors 115 for passenger access with windows 155 thereon which preferably do not open, a front windshield 157, and a rear window 153. In an upper portion of armored envelope 110, such as the roof, there is a hatch 113 for enabling shooting at an enemy and for emergency escape from vehicle 100. Armored envelope 110 also has a climate control unit 160 to service the area enclosed thereby, which typically serves as a passenger compartment or cab. Vehicle 100 has a power plant 120, preferably an engine typical of those which would be found in a small car, to provide power thereto. It should be noted that in a typical dune buggy, a relatively small engine, such as might be found on a large motorcycle, provides sufficient power to drive the vehicle, while the present invention requires a larger, more powerful, engine because of the weight of armored envelope 110. Vehicle 100 has a pick up bed 127 which may be lifted to provide access to power plant 120 and may, when not raised, be used for storage outside armored envelope 110. In the present embodiment, transmission 125 transfers power from engine 120 to differential 130, which powers each rear wheel 140 via its own independent drive 135. Rear wheels 140 have independent suspensions 145. In the present embodiment, in common with most dune buggies, each front wheel 143 has an independent double wishbone suspension 145. It should further be noted that, while the present embodiment is a two wheel drive vehicle with rear wheel drive, the present invention includes two wheel drive vehicles with front wheel drive, as well as four wheel drive vehicles.

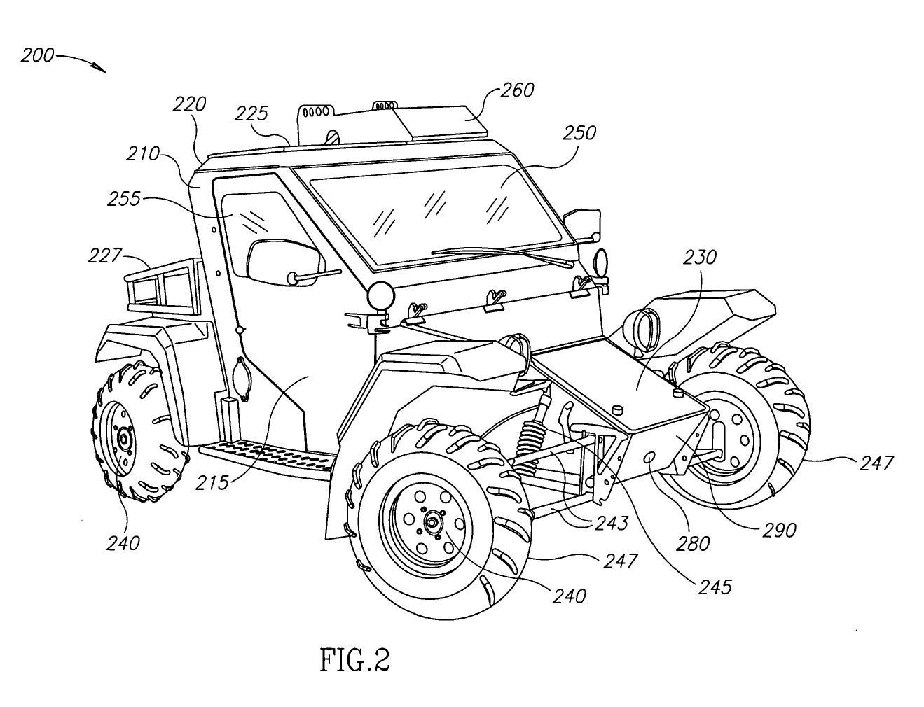

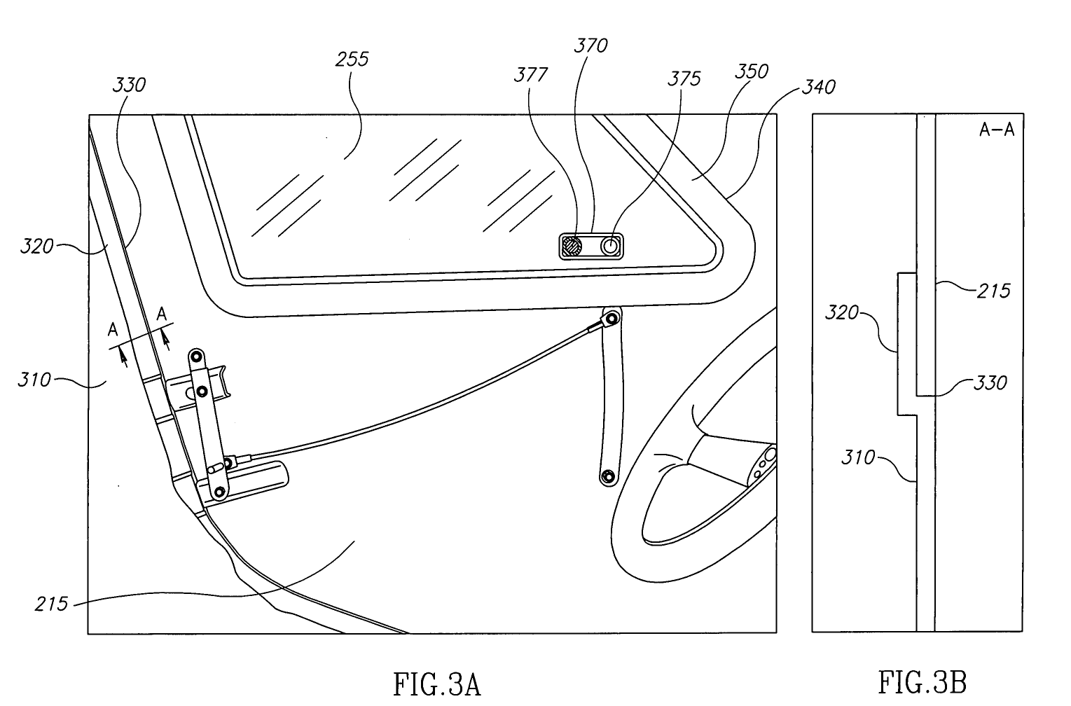

Referring now to FIG. 2, there is shown a light armored vehicle, referred to generally as 200, constructed and operative in accordance with a preferred embodiment of the present invention shown schematically in FIG. 1. The present preferred embodiment is based on an off road vehicle commonly called a “dune buggy,” which is light, highly maneuverable, and able to function in many types of terrains and conditions, but it should be noted however that the present invention includes a light weight armored vehicle based on any other type of all terrain vehicle. Vehicle 200 is armored by an envelope or enclosure of armor plate steel, different portions of which are generally perpendicular 210, parallel 220, and angled 230 with respect to the vehicle chassis. Vehicle 200 typically has four wheels 240, each having its own individual suspension 245, on which are mounted all terrain tires 247. The front wheels shown in the drawing each have double wishbone suspension 243, commonly used in dune buggies and other all terrain vehicles. In common with dune buggies and other all terrain vehicles, vehicle 200 is equipped with tires that can continue to function even when deflated; which, in the present embodiment, are “bead lock” tires, wherein the tires 247 are sealed onto the rim of the wheel 240. Vehicle 200 has a door 215 on each side and a windshield 250 and windows 255; windshield 250 and windows 255 typically are cofigured to be unopenable. In an alternative embodiment of the present invention, gun ports such as that described hereinbelow and shown in FIG. 3A, are provided in the windows and may be also be provided in the windshield. The present invention preferably further includes a climate control unit 260, which, in the present embodiment, is a heat pump air conditioning unit, to provide climate control for the interior or cab of vehicle 200. Behind the cab, there is a pick up bed 227 which can be raised to provide access to the engine of vehicle 200 and which, when not raised, as shown in FIG. 2, can be used for storage outside the cab.

The present invention provides an all terrain rapid response vehicle that affords protection to a desired military standard by means of an armored envelope enclosing it. The present embodiment is configured to provide protection against a level 6 weapon according to United States National Institute of Justice standard 0108-01, which means it is able to withstand a 7.62 mm armor-piercing round. This requires 10 mm ballistic steel armored plate for all perpendicular portions 210 of the envelope, as described hereinabove, which must be able to stop a directly impinging projectile of the type specified. The angled portions 230, as is clear to those familiar with the art, can, because of their angular orientation which, in the present embodiment, is in the range of 40° to 75° relative to the vehicle chassis, be thinner than that required for perpendicular portions 210 and still provide the required protection because projectiles will be deflected from the angled portions 230 of the armored envelope. In the present embodiment, 3 mm ballistic steel armored plate is used, though in some cases, up to 7 mm may be desired. In either case, the use of thinner armor plate provides a significant saving in weight in vehicle 200, resulting in enhanced speed, maneuverability, and reliability, without compromising the degree of protection provided by the armored enclosure. Similarly, windows 255 and windshield 250 are fabricated of a bullet-proof transparent medium, such as glass, plastic, or a combination thereof, which, in the present embodiment, is 45 mm thick. It should be noted that the present invention further includes use of an armored envelope for vehicle 200 which may be relatively thicker or thinner, depending on the degree of protection required. Further, alternative embodiments of the present invention preferably include an armored undercarriage to complete the armored enclosure to provide protection from below.

A further feature of the present embodiment is a hatch 225 opening on the roof of vehicle 200 for shooting and for emergency escape from vehicle 200. In a further alternative embodiment of the present invention, a munitions system may be preferably included near hatch 225 on the outside of vehicle 200 to provide offensive capability thereto. Further, a seat for the user of the munitions system may be mounted on pick up bed 227 behind the cab.

Referring briefly to FIG. 3A, there is shown an enlarged view of a portion of a door 215 as viewed from the inside of the light armored vehicle 200 of FIG. 2.It should be noted that door 215 is preferably surrounded by an overlap 320 of armored plate 310 along the seam 330 where it is mounted on the side of vehicle 200, as shown in the cross-sectional inset A-A shown in FIG. 3B. Similarly window 255 is preferably surrounded by an overlap of armored plate along the seam 340 where it is mounted on door 215. This is to provide protection against penetration by gunfire of the armored enclosure via one of the seams 330, 340. Window 255 also has installed therein gun port 370 to provide users of vehicle 200 the capability to shoot from within the safety of the armored envelope. Gun port 370 has an aperture 375 for a gun barrel and sliding cover 377 to close aperture 375 when not being used.

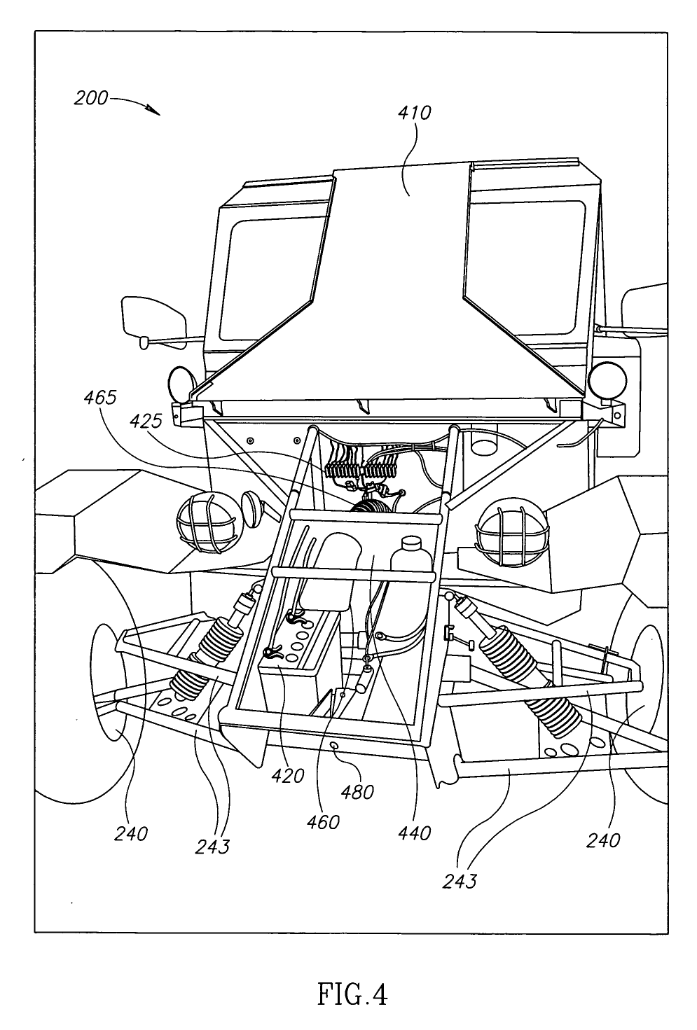

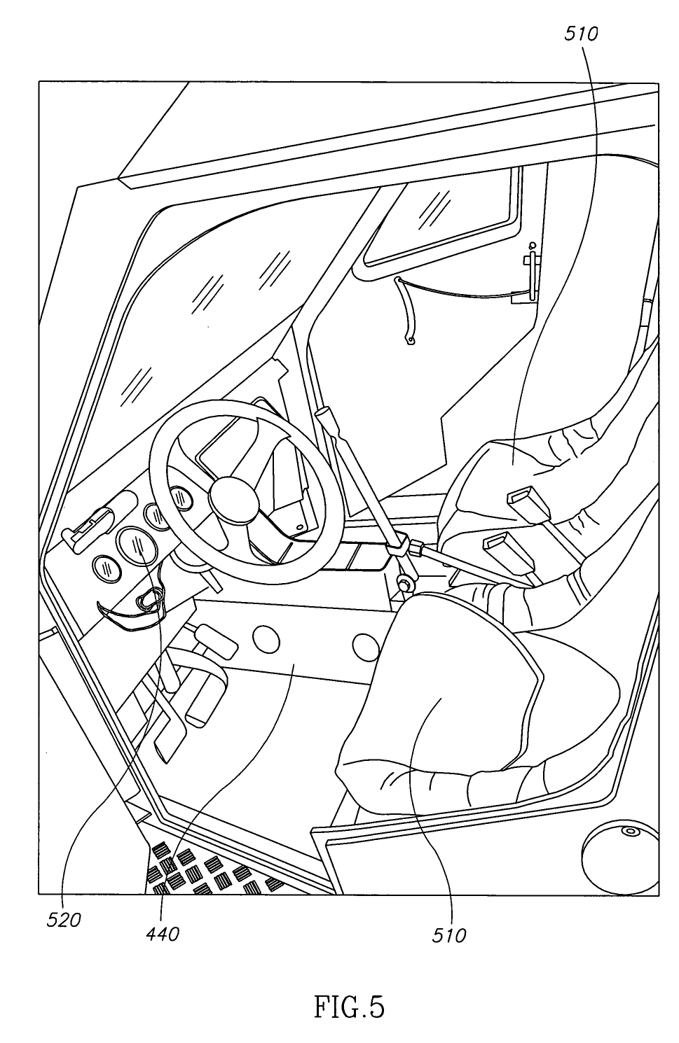

Referring now to FIG. 4, it is seen that vehicle 200 is preferably fabricated with a box channel 440 to provide structural stability and strength thereto. Box channel 440 runs the length of vehicle 200, from the front as seen in FIG. 4, through the interior as shown in FIG. 5, to the rear. As can be seen in FIG. 4, box channel 440 encloses and thus also provides protection to selected components or subsystems of vehicle 200. Battery 420 and fuse panel 425 with fuses can be seen in box channel 440. Above battery 420 is a filtering inlet 460 for an air intake conduit 465 of the engine, which continues through box channel 440 to the rear of vehicle 200 where the engine is located. As seen in FIG. 2, there is provided an air inlet port 280, seen in the present embodiment on the lower front plate 290 of the vehicle armor, through which air enters box channel 440. Returning now to FIG. 4, air enters air inlet port 480 and continues via filtering air inlet 460 and the air intake conduit 465 to the engine in the rear of vehicle 200. Also shown is the double wishbone suspension 243 of each front wheel 240.

A portion of the interior of light armored vehicle 200 is shown in FIG. 5. The present embodiment includes two seats 510, including one for the driver, though light armored vehicles for more than two riders are also included in the present invention. The continuation of box channel 440 runs between the two seats 510. The dashboard 520 and controls are also readily seen.

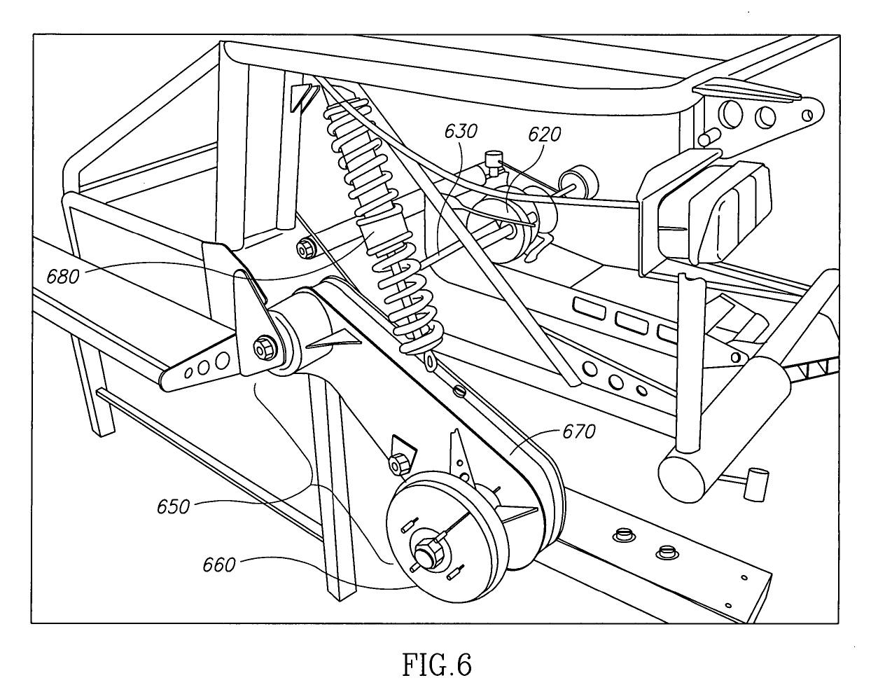

Referring now to FIG. 6, there is shown a detailed view of the drive train 630 and the final drive, referenced generally 650, of the rear wheels 660 of the light armored vehicle 200 of FIG. 2. Power from the vehicle engine and transmission is transmitted via differential 620 to drive train 630. Drive train 630 is linked by final drive 650, to rear wheel 660 to provide power thereto. In the present embodiment, final drive 650 is a chain drive located within chain guard 670 and therefore not shown. Each rear wheel 660 has its own drive train 630 and final drive 650 for independent power, as well as its own suspension 680 mounted on chain guard 670.

As was noted hereinabove, a typical dune buggy or ATV can suffice with a relatively small engine, such as might be found on a large motorcycle, to provide sufficient power to drive the vehicle. The present embodiment, because of the extra weight of the armored plate and some ruggedizing features such as the box channel 440 (as shown in FIGS. 4 and 5), employs a small car engine to provide sufficient power to run vehicle 200. In the present embodiment, the engine is an approximately 1.3 liter water-cooled engine with two thermostatically-controlled fans providing cooling air flow to the radiator. Another feature of the present embodiment is an extra large spacing of typically 3-4 inches between the radiator and the fans to facilitate improved air movement and hence, more effective cooling to the engine for the hot environments and extreme operating conditions often encountered in military applications.

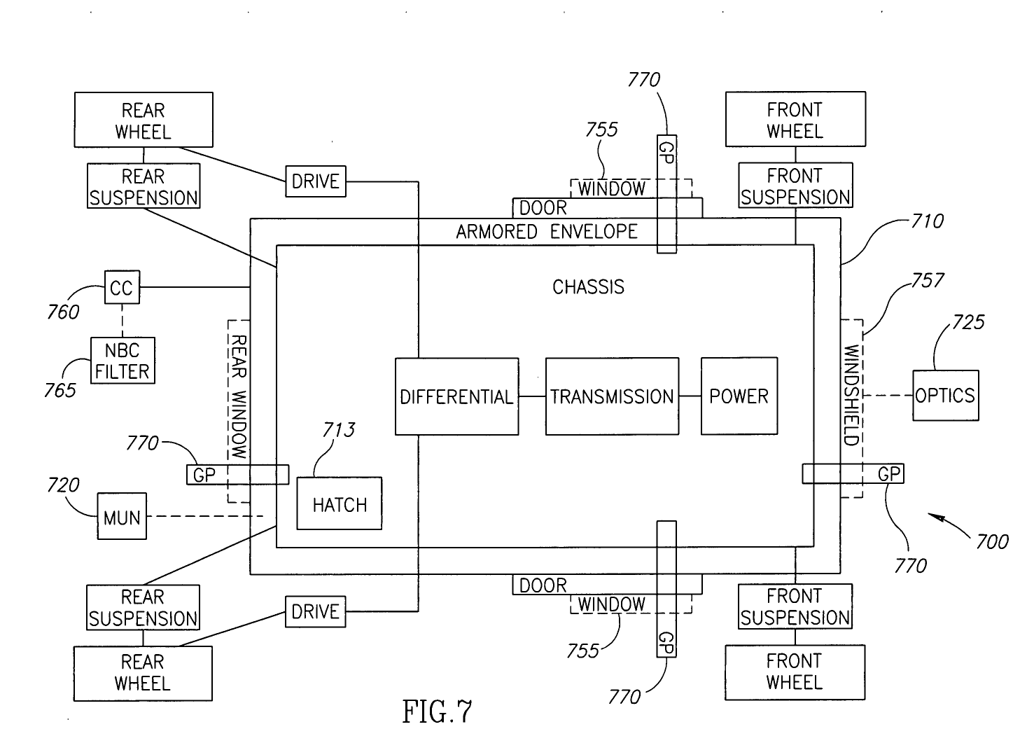

Referring now to FIG. 7, there is shown a block diagram of a light armored vehicle, referred to generally as 700, operative in accordance with further embodiments of the present invention. Vehicle 700 has all the features of vehicle 100 shown in the block diagram of FIG. 1, but also includes additional features which may preferably be added as options thereto. Reference is made herein only to those new features and not to features already discussed hereinabove except where they connect or relate to the new features. In order to provide offensive capability to vehicle 700, a munitions system 720 is mounted preferably on the outside of armored envelope 710, preferably near hatch 713. Offensive capability is further enhanced by equipping windows 755 and windshield 757 with gun ports 770. Munitions system 720 is further served by optics system 725 to allow targets to be seen, designated, aimed at and fired upon. Optics system 725 may advantageously include capabilities such as night vision, thermal imaging, laser guided projectiles, and support for a heads-up display. In alternative embodiments of the present invention, optics system 725, for example, a heads-up display, can further allow vehicle 700 to be driven and to function without windows 755 or windshield 757; and gun ports 770 may be suitably located on armored envelope 710. In order to provide protection to the occupants of vehicle 700 against nuclear, biological, or chemical (NBC) threats, climate control unit 760 is preferably configured with blowers that supply positive air pressure within armored envelope 710 and is further configured with filtering apparatus 765 on the air inlets associated therewith to remove NBC substances from incoming air, in accordance with military standards.

It will further be appreciated by persons skilled in the art that the scope of the present invention is not limited by what has been specifically shown and described hereinabove, merely by way of example. Rather, the scope of the present invention is defined solely by the claims, which follow.

1. A light, armored, all terrain vehicle, including:
a chassis with an armored envelope mounted thereon to protect preselected components and the occupants thereof;
at least four wheels including two rear wheels;
an engine for producing driving energy;
a total drive train for transmitting driving energy which includes a transmission, a drive shaft, and a rear differential;
a rear drive for transmitting driving energy from said total drive train to said rear wheels;
a frame including at least one box channel providing structural stability and strength to said vehicle;
an air intake arrangement to provide air to said engine; and
a cooling arrangement for cooling said engine,
wherein said total drive train, said rear drive, said at least one box channel, and said air intake arrangement are enclosed within said armored envelope;
and wherein said armored envelope is fabricated to provide a predetermined degree of protection to its contents.

2. A vehicle according to claim 1, wherein said armored envelope includes perpendicular portions, parallel portions, and angled portions, with respect to said chassis; and wherein said perpendicular portions are fabricated of relatively thick armored plate and said angled and parallel portions are fabricated of relatively thin armored plate.

3. A vehicle according to claim 2, wherein said angled portions of said armored envelope are oriented at an angle in the range of 45° to 70° relative to the horizontal surface.

4. A vehicle according to claim 1, wherein said armored envelope further includes doors.

5. A vehicle according to claim 4, wherein said armored envelope and said doors further include overlap portions at the seams therebetween, providing protection from penetration of projectiles via said seams.

6. A vehicle according to claim 1, wherein said armored envelope further includes unopenable window portions to provide visibility from therewithin.

7. A vehicle according to claim 6, wherein said window portions include gun ports at preselected locations.

8. A vehicle according to claim 1, wherein said predetermined degree of protection provided by said armored envelope is protection against a 7.62 mm armor-piercing round.

9. A vehicle according to claim 2, wherein said relatively thick armored plate is ballistic steel of a thickness of at least 10 mm and said relatively thin armored plate is ballistic steel of a thickness in the range of 3 to 7 mm.

10. A vehicle according to claim 1, wherein said armored envelope further includes an undercarriage fabricated of armor plate, thereby completing the enclosure provided by said armored envelope.

11. A vehicle according to claim 1, wherein said at least one box channel further includes an air conduit for said air intake arrangement.

12. A vehicle according to claim 1, wherein said rear drive includes an independent rear wheel drive train for each of said rear wheels.

13. A vehicle according to claim 1, wherein said wheels include tires fabricated to continue to function when deflated.

14. A vehicle according to claim 13, wherein said tires are bead lock tires.

15. A vehicle according to claim 1, wherein said cooling arrangement includes a radiator and at least one fan with a predetermined spacing between said radiator and said at least one fan to allow sufficient air circulation through said radiator for effective functioning of said cooling arrangement.

16. A vehicle according to claim 1, wherein said cooling arrangement further includes at least two fans.

17. A vehicle according to claim 15, wherein said predetermined spacing between said radiator and said at least one fan is in the range of 3 to 4 inches.

18. A vehicle according to claim 1, wherein said armored envelope further includes a hatch located in an upper portion thereof.

19. A vehicle according to claim 1, further including a climate control system.

20. A vehicle according to claim 19, wherein said climate control system is configured to NBC standards and includes at least one blower for maintaining positive air pressure within said armored envelope and a filtered air inlet.
